(19) United States
(12) Patent Application Publication
(10) Pub. No.: US 2025/0206489 A1
(43) Pub. Date: Jun. 26, 2025

(54) PACKAGE RELABELING SYSTEM

(71) Applicant: United States Postal Service, Washington, DC (US)

(72) Inventors: Scott R. Bombaugh, Merrifield, VA (US); John M. Dunlop, Merrifield, VA (US); Jordan S. Musselman, Merrifield, VA (US); Anthony B. Taylor, Merrifield, VA (US); Jaimin Farkiwala, Merrifield, VA (US); Thomas Welch, Merrifield, VA (US); Edward F. Houston, Merrifield, VA (US); Amit Cholkar, Merrifield, VA (US)

(21) Appl. No.: 18/990,444

(22) Filed: Dec. 20, 2024

Related U.S. Application Data
(60) Provisional application No. 63/613,633, filed on Dec. 21, 2023.

(51) Int. Cl. B65C 9/40; B07C 3/00; B65C 9/02; B65C 9/46

(52) U.S. Cl. CPC B65C 9/40; B07C 3/005; B65C 9/02; B65C 9/46; B65C 2009/402

(57) ABSTRACT

A system may include at least one conveyor lane configured to transport items. A system may include a scan tunnel to identify any items containing unreadable or unscannable labels transported by the at least one conveyor lane. A system may include a sorter configured to redirect items traveling on the at least one conveyor lane. A system may include a relabeling component configured to apply a new label to any items that contain an unreadable or unscannable label.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of priority of U.S. Provisional Patent Application 63/613,633 filed Dec. 21, 2023, the entire contents of which are hereby incorporated by reference.

### BACKGROUND

The disclosure relates to a sorting and relabeling system used in the delivery of items. More specifically, it relates to a system that can sort items by delivery location or other indicator based on information retrieved after scanning a label and additionally can relabel any items that were not properly labeled and assign delivery information to the new label.

### SUMMARY

In some aspects, a method for sorting and relabeling items comprises: receiving items, via a sorting system; scanning a label on an item; generating a label error if the label on an item is unreadable or unscannable; redirecting items with label error to a relabeling system; applying a new label to an item; and associating item or delivery information with the new label.

In some aspects, the techniques described herein relate to a method, further including prior to scanning a label on an item, singulating the items, via an automatic singulator.

In some aspects, the techniques described herein relate to a method, further including: after scanning a label on an item, receiving item or delivery information associated with the label; and redirecting an item based on the item or delivery information received.

In some aspects, the techniques described herein relate to a method, wherein redirecting items with a label error to a relabeling system includes: determining if the item is a first-time bag or a nonsingulated item; redirecting any first-time bags or nonsingulated item to a flatten and face area of the relabeling system; and redirecting all other items to an item relabeling area of the relabeling system.

In some aspects, the techniques described herein relate to a method, further including: flattening any first-time bags; singulating any nonsingulated items; and redirecting flattened and singulated items back to the sorting system.

In some aspects, the techniques described herein relate to a method, wherein redirecting items with a label error to a relabeling system includes: redirecting items to a flatten and face area of the relabeling system; flattening any first-time bags; singulating any nonsingulated items; redirecting flattened and singulated items back to the sorting system. redirecting all other items to an item relabeling area of the relabeling system.

In some aspects, the techniques described herein relate to a method, wherein associating item or delivery information with the new label includes: capturing an image of the previous label applied to the item; transmitting the image to an image processing system; extracting item or delivery information from a previous label of the item; associating the item or delivery information of the previous label with the new label; and uploading the label and item or delivery information to a database.

In some aspects, the techniques described herein relate to a method, wherein the image captured is an image of the previous label and of the new label.

In some aspects, the techniques described herein relate to a method, wherein extracting item or delivery information from a previous label of the item includes: transmitting the image of the previous label to an automatic processing component; automatically converting text from the previous label into a digital format;

In some aspects, the techniques described herein relate to a method, wherein extracting item or delivery information from a previous label of the item includes: transmitting the image of the previous label to a manual processing unit; and manually converting text from the previous label into a digital format.

In some aspects, the techniques described herein relate to a method for relabeling items, the method including: applying a new label to an item; capturing an image of the previous label applied to the item; transmitting the image to an image processing system; extracting item or delivery information from a previous label of the item; associating the item or delivery information with the new label; and uploading the label and item or delivery information to a database.

In some aspects, the techniques described herein relate to a method, wherein applying a new label to an item includes applying a new label to an item on proximate a previous label.

In some aspects, the techniques described herein relate to a method, wherein applying a new label to an item includes applying a new label to an item on a side of the item where a previous label is located.

In some aspects, the techniques described herein relate to a method, wherein extracting item or delivery information from a previous label of the item includes: transmitting the image to an automatic processing component; automatically converting text from a previous label into a digital format; determining the result of the automatic conversion; transmitting the image to a manual processing unit based on the result of the automatic conversion; and manually converting text from a previous label into a digital format based on the result of the automatic conversion.

In some aspects, the techniques described herein relate to a system for sorting and relabeling items, the system including: a sorting component, including: at least one conveyor lane configured to transport items; a scan tunnel to identify any items containing unreadable or unscannable labels transported by the at least one conveyor lane; a sorter configured to redirect items traveling on the at least one conveyor lane; and a relabeling component configured to apply a new label to any items that contain an unreadable or unscannable label.

In some aspects, the techniques described herein relate to a system, wherein the sorting component further includes an automated singulator configured to singulate any items traveling on the at least on conveyor lane.

In some aspects, the techniques described herein relate to a system further including a processing component, the processing component configured to associate item or delivery information associated with a previous label of an item to the new label applied by the relabeling component.

In some aspects, the techniques described herein relate to a system, wherein the processing component includes: an automated processing component configured to receive an image of a label on an item and automatically convert text from the image into a digital format; and a manual processing component configured to receive an image of a label on an item and manually convert text from the image into a digital format.

In some aspects, the techniques described herein relate to a system, wherein the relabeling component includes: a flatten and face area configured to flatten any bags and singulate any non singulated items; and an item relabeling area configured to apply a new label to any items with an unreadable or unscannable label.

In some aspects, the techniques described herein relate to a system, wherein the scan tunnel is further configured to scan a label and receive associated item or delivery information associated with the scanned label from a database.

In some aspects, the techniques described herein relate to a method for processing items, the method including: receiving, in a sorting system, an item, the sorting system including a scanner; scanning, by the scanner, a label on an item; assigning an error designation to the item based on the scanning; automatically redirecting the item to a relabeling component within the sorting system based on the assigned error designation; applying a new label to the item; receiving delivery information for the item; and associating the delivery information with the new label.

In some aspects, the techniques described herein relate to a method, further including prior to scanning a label on an item, singulating the items, via an automatic singulator.

In some aspects, the techniques described herein relate to a method, wherein assigning the error designation to the item includes determining, by the scanner, that the label cannot be fully read.

In some aspects, the techniques described herein relate to a method, wherein determining that the label cannot be fully read includes determining that a computer readable code on the label is incomplete or damaged.

In some aspects, the techniques described herein relate to a method wherein the label has a delivery point indicated thereon, and wherein determining the label cannot be fully read includes determining that a delivery point cannot be interpreted by the scanner.

In some aspects, the techniques described herein relate to a method, wherein redirecting the item to a relabeling component includes: determining that the item was scanned for a first time; and redirecting the item being scanned for the first time to a flatten and face area of the sorting system.

In some aspects, the techniques described herein relate to a method, wherein associating the delivery information with the new label includes: capturing an image of the label on the item; transmitting the image to an image processing system; extracting the delivery information from the label on the item; and associating the extracted delivery information with the new label.

In some aspects, the techniques described herein relate to a method, wherein extracting item or delivery information from a previous label of the item includes: transmitting the image of the label on the item to an automatic processing component; and automatically converting text from the previous label into a digital format.

In some aspects, the techniques described herein relate to a method, wherein extracting item or delivery information from the label on the item includes: transmitting the image of the previous label to a manual processing unit; and manually converting text from the previous label into a digital format.

In some aspects, the techniques described herein relate to a method, further including capturing by a relabeling scanner, an image of the item, the image including both the label and the new label.

In some aspects, the techniques described herein relate to a system for sorting and relabeling items, the system including: a sorting component including: at least one conveyor lane configured to transport a plurality of items, each of the items having a label thereon; a scanner configured to read the label on each of the plurality of items to identify any of the plurality of items having unreadable or unscannable labels thereon; a sorter configured to redirect items traveling on the at least one conveyor lane having unreadable or unscannable labels thereon; and a relabeling component configured to apply a new label to each of redirected items having unreadable or unscannable labels thereon.

In some aspects, the techniques described herein relate to a system further including one or more processors in communication with the sorting component, wherein the one or more processors are configured to: receive delivery information for one the items having unreadable or unscannable labels thereon; associate the received delivery information for the one item of the redirected items with the new label applied to the one item of the redirected items.

In some aspects, the techniques described herein relate to a system, wherein the scanner is further configured to image the label on each of the plurality of items, and wherein the one or more processors are further configured to receive the image of the label on one of the plurality of items and automatically convert text from the image into a digital format to generate the delivery information.

In some aspects, the techniques described herein relate to a system, wherein the one or more processors are further configured to receive the delivery information from a manual processing component configured to receive an image of a label on an item and manually convert text from the image into a digital format.

In some aspects, the techniques described herein relate to a system wherein the relabeling component includes: a flatten and face area configured to flatten any bags and singulate any non singulated items; and an item relabeling area configured to apply a new label to any items with an unreadable or unscannable label.

In some aspects, the techniques described herein relate to a system, wherein the scanner is further configured to: determine that one or more items of the plurality of items were scanned for a first time; and redirect the item being scanned for the first time to a flatten and face area of the sorting system

In some aspects, the techniques described herein relate to a method for relabeling items, the method including: applying a new label to an item; capturing an image of the previous label applied to the item; transmitting the image to an image processing system; extracting item or delivery information from the previous label of the item; associating the item or delivery information with the new label; and uploading the new label and item or delivery information to a database.

In some aspects, the techniques described herein relate to a method, wherein applying a new label to an item includes applying the new label to the item at a location proximate the previous label.

In some aspects, the techniques described herein relate to a method, wherein extracting item or delivery information from a previous label of the item includes: transmitting the image to an automatic processing component; automatically converting text from a previous label into a digital format; determining the result of the automatic conversion; transmitting the image to a manual processing unit if the result of the automatic conversion is unsuccessful; and manually converting text from a previous label into a digital format if the result of the automatic conversion is unsuccessful.

In some aspects, the techniques described herein relate to a method, further including sending the item or delivery information to a device that scans the new label.

### BRIEF DESCRIPTION OF THE DRAWINGS

The foregoing and other features of the disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1A shows a schematic view of a system for sorting items and relabeling items.

FIG. 1B shows a top view of an item relabeling area.

FIG. 1C shows an isometric view of a relabeling workstation.

FIG. 2 shows an example label.

FIG. 3 shows a block diagram schematically illustrating various components of the system of FIGS. 1A-1C.

FIG. 4 shows a block diagram of a process for relabeling an item using a system for sorting items and relabeling items.

FIG. 5 shows a block diagram of another process for relabeling an item using a system for sorting items and relabeling items.

FIG. 6 shows a block diagram of a process for associating information from a previous label with a new label.

### DETAILED DESCRIPTION OF THE PREFERRED EMBODIMENT

In the following detailed description, reference is made to the accompanying drawings, which form a part hereof. In the drawings, similar symbols typically identify similar components, unless context dictates otherwise. Thus, in some embodiments, part numbers may be used for similar components in multiple figures, or part numbers may vary depending from figure to figure. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein and illustrated in the Figures, can be arranged, substituted, combined, and designed in a wide variety of different configurations, all of which are explicitly contemplated and made part of this disclosure.

Reference in the specification to “one embodiment,” “an embodiment,” or “in some embodiments” means that a particular feature, structure, or characteristic described in connection with the embodiment is included in at least one embodiment of the invention. Moreover, the appearance of these or similar phrases throughout the specification do not necessarily all refer to the same embodiment, nor are separate or alternative embodiments necessarily mutually exclusive. Various features are described herein which may be exhibited by some embodiments and not by others. Similarly, various requirements are described which may be requirements for some embodiments but may not be requirements for other embodiments.

As used herein, the term item may refer to discrete articles in the distribution network, such as mail pieces, letters, flats, magazines, periodicals, packages, parcels, freight, cargo, suitcases, products, and the like. The term item can also refer to trays, containers, hoppers, bins, conveyances, crates, boxes, bags, and the like. An exemplary distribution network may be the United States Postal Service (USPS). With the large number of items, including letters, flats, parcels, etc., and the large number of addresses to service, processing speed is important to efficient operation of the distribution network. For example, the United States Postal Service delivers more than 528 million mailpieces to over 152 million destinations (addresses) every day. Although the United States Postal Service is discussed herein as an exemplary distribution network, it will be understood that this disclosure is not limited thereto.

An item distribution network, such as the United States Postal Service (USPS) can deliver to a plurality of destinations each day according to specific daily routes. A distribution network may comprise multiple levels, any one of, or each of which may utilize item processing equipment, such as sortation equipment, singulators, shingulators, and the like. For example, a distribution network may comprise regional distribution facilities, hubs, and unit delivery facilities, or any other desired level. Each of these facilities may utilize flats sequencing systems in order to properly sort and distribute items as required en route to delivery to a final destination. For example, a nationwide distribution network may comprise one or more regional distribution facilities having a defined coverage area (such as a geographic area), designated to receive items from intake facilities within the defined coverage area, or other regional distribution facilities. The regional distribution facility can sort items for delivery to another regional distribution facility, or to a hub level facility within the regional distributional facility's coverage area. A regional distribution facility can have one or more hub level facilities within its defined coverage area. A hub level facility can be affiliated with a few or many unit delivery facilities and can sort and deliver items to the unit delivery facilities with which it is associated. In the case of the United States Postal Service, the unit delivery facility may be associated with a ZIP code. The unit delivery facility receives the items, sorts and stages the items for delivery to the destinations within the unit delivery facility's coverage area.

At each level, items can be sorted according to item type, delivery end point, class of service, or any other criteria. Items which are intended for delivery within a defined geographic area near the processing facility, or intended for delivery to a particular destination or plurality of destinations, can be sorted by separating these items from items with other, different delivery end points. Items intended for delivery to a destination outside of the defined geographic area, particular destination or plurality of destinations can be sorted and sent to another processing facility nearer their delivery end points.

The system described herein provides for faster and more efficient sorting of items and for the relabeling of items without disrupting the flow of items. In particular, delivery services, often receive large numbers of mail items every day that need to be processed and delivery as soon as possible. Delivery services often will sort incoming mail items by delivery location, delivery point, destination, address or by another indicator. The delivery location information is often printed on a distribution label, encoded within a computer readable code on the label, or associated with the computer readable code in a memory or database. The label is on the mail item, and the label can be scanned by a sorting system or other device. However, if in an item was not properly labeled or the existing label cannot be properly read by the system this can create a disruption in the sorting system as a whole or at least cause a delay in the delivery of that specific item. In some cases, where a label cannot be read electronically, such as when a label cannot be scanned because the label is damaged or missing, the item, such as a package, is incorrectly positioned to be read by the scanner, or the system is unable to parse or recognize the characters in the label on the item, the item processing equipment or item sortation equipment cannot further process an item. Currently, where the item's label cannot be automatically read or labelled, the item is moved out of the sortation stream and to a manual operator who interprets the label and inputs the interpretation of the label into an interface. Sometimes this manual operator location is in a different portion of the facility as the sorting apparatus, and sometimes the location of the manual operator is in a different facility. Moving the item out of the sortation stream creates delay and interrupts the sorting process.

Described herein is a system for identifying, sorting, and relabeling items without causing a significant delay in the processing and delivery of the items. The system may include a sorting component and a relabeling component. The sorting component may scan a label of incoming mail items and access a database with information associated with the scanned label. The sorting component may then direct items to different locations based on the delivery information associated with the scanned label. If the sorting component is unable to scan a mail item, the sorting component may automatically direct that item to the relabeling area. In some embodiments, the item may first be directed to a flatten and face area, where the item may be flattened out, reoriented, or singulated to see if that alleviates the label issue. A reader, such as a scanner or camera at the flatten and face area can determine whether the label can be read following the flattening, reorientation, or singulation. If the item can be read, the item is automatically directed back into the sortation stream in the item processing equipment.

Items that cannot be flattened or cannot be singulated, or where the flattening, reorienting, or singulation does not result in a code or label that can be read, the item is automatically directed to the relabeling area. An automated system or an operator may apply a new label to the mail item and the item is sent to a scanner. The scanner may capture an image of the new label and the previous label and send the image(s) to a processing system. The processing system may automatically or manually input the delivery information associated with the previous label and associate it with the new label. The item is then reintroduced to the sortation stream, where it can be sorted according to its updated or new delivery information.

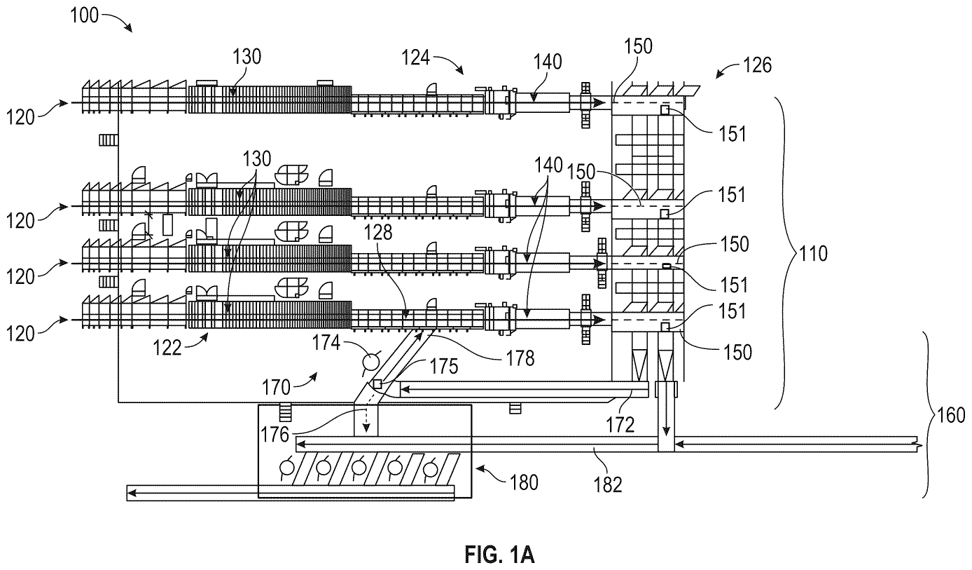

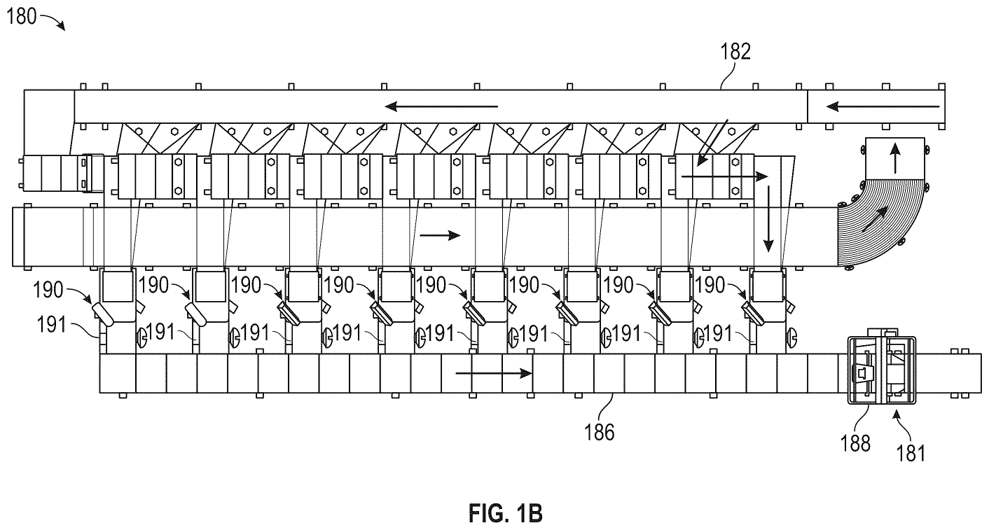

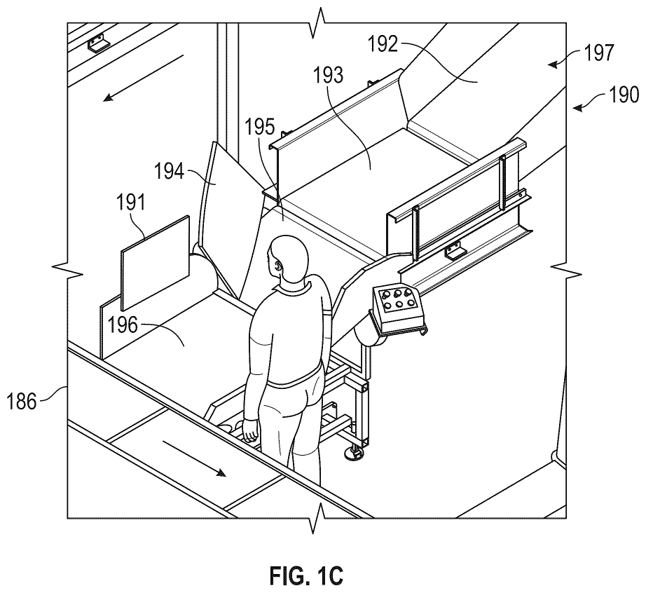

FIG. 1A shows a schematic view of a system 100 for sorting items and relabeling items. The system 100 includes a sorting system 110 and a relabeling system 160. The sorting system 110 includes a plurality of conveyor lanes 120. Each conveyor lane 120 includes an automatic singulator 130, a scan tunnel 140, and a sorter 150. Each conveyor lane 120 conveys items from a location upstream the sorting area 110, such as a staging area, to a sorting apparatus located downstream of the sorting area 110, where items are sorted according to the delivery point, delivery destination, or address to which the item are intended for delivery. In some embodiments, the system 100 can have only one conveyor lane 120, or have many conveyor lanes 120, as desired for efficient operation. The sorting apparatus can be part of the sorter 150 or can include additional sortation features not depicted in FIG. 1A.

In some embodiments, the items being conveyed by each conveyor lane 120 may include articles of mail. The articles of mail may include items of various size and shape, such as letters, flats, bags, packages, magazines, catalogs, and parcels. One or more of the items on the conveyor lanes 120 can be redirected to the relabeling system 160, rather than sorted downstream of the sorting area 110. The sorting system 110 identifies items that have defective or missing labels and redirect the identified items to the relabeling system 160.

The relabeling system 160 is located proximate the sorting system 110 and includes a flatten and face area 170 and an item relabeling area 180. The relabeling system 160 is discussed in further detail below. In some embodiments, the item sorting equipment is capable of processing 2500 items per hour. The input and output conveyors of the sorting system 110 can be 30″ wide and can be located at floor level, at any location up to 10-15′ above the floor, or higher.

The automatic singulators 130 are located at a first position 122 of each conveyor lane 120. The first position 122 is at a location upstream from the scan tunnel 140. The automatic singulator 130 is configured to create space between individual items traveling on the conveyor lane 120. In some embodiments, the automatic singulator is configured to create space or separation between individual items traveling on the conveyor lane 120 such that only one item travels through the scan tunnel 140 at a time. In some embodiments, the automatic singulator 130 comprises multiple conveyors and/or rollers each configured to convey items at different speeds. In some embodiments, the automatic singulator 130 receives items and conveys them along the multiple conveyors and/or rollers at different speeds. This may be beneficial for creating space between each item traveling along each conveyor lane 120.

The scan tunnel 140 is located at a second position 124 on each conveyor lane 120. The second position 124 is at a location that is downstream from the automatic singulator 130 and upstream from the sorter 150. The scan tunnel 140 is configured to scan labels on items being conveyed along each conveyor lane 120. In some embodiments, the scan tunnel 140 is configured to read a barcode, a QR code, or other scannable medium on the label. In some embodiments, the scan tunnel 140 includes at least one camera configured to read or scan a label on an item as passes under the scan tunnel 140. In some embodiments, the at least one camera is configured to capture an image of a label or a portion of a label affixed to or located on an item and/or one or more sides of the item. In some embodiments, the scan tunnel 140 may be a one-, two-, three-, four- or more sided scan tunnel configured to scan multiple or all sides simultaneously of incoming items. The scan tunnel 140 may be in communication with a database or processor. In some embodiments, when the scan tunnel 140 scans a label, the scan tunnel 140 sends a signal to the database or processor requesting item or delivery information associated with the scanned label. In some embodiments, the item or delivery information includes a delivery name and/or address, a requested or estimated date of delivery, sender name and/or address, weight of the item, a delivery class, type of item, such as an envelope, a package, or a bag, and/or other information. In some embodiments, the label comprises a computer readable code encoding the delivery information or associated with the delivery information. Upon sending a signal to the database, the scan tunnel 140 may receive the associated item or delivery information from the database. All the functions of the scan tunnel 140, or other components described herein, can be performed by the component, or by one or more processors in communication with the component, or by a combination of processors in the component and processors located remote from the component in networked or wireless communication with the component.

In some embodiments, the scan tunnel 140 is configured to scan a single side or less than all sides of an incoming item. In this embodiment, the scan tunnel 140 may further include an actuator configured to rotate or orient items traveling through the scan tunnel 140. In some embodiments, the actuator may be configured to orient an item in a first orientation such that a single or multiple sides can be scanned by the scan tunnel 140. If the scan tunnel 140 does not detect a label on the scanned sides of the item, the scan tunnel 140 may send a signal to the actuator (not shown). In response to the signal received, the actuator may orient the item in a second orientation such that a different side or different sides are exposed to the scan tunnel 140 relative to the first orientation. This may continue until all sides of an item have been scanned or the scan tunnel 140 detects a label on the item. In some embodiments, the actuator may automatically sort, route, shunt, or otherwise direct the item to the relabeling system 160, which will be described in greater detail elsewhere herein.

The scan tunnel 140 is further configured to assign an error designation to an item when the scan tunnel 140, or one or more processors in communication therewith, are unable to read, scan, interpret, parse, etc., all or a portion the label of the item after scanning at least one side of an item. In some embodiments, the error designation may be referred to as a label error. In some embodiments, the scan tunnel 140, or one or more processors in communication with the scan tunnel, are configured to assign an error designation to an item when the item does not have a label or has a label that is unreadable or unscannable in part or in whole. In some embodiments, the scan tunnel 140 is configured to assign an error designation to an item when it identifies that the item has not been properly singulated by the automatic singulator 130. The scan tunnel 140 may be configured to identify items that have an unreadable or unscannable label or items that have not been properly singulated, via one or more readers or cameras.

In some embodiments, the scan tunnel 140 may include a weight sensor and may be configured to identify items that have not been properly singulated based on information received from the weight sensor. In some embodiments, upon scanning a label on an item the scan tunnel 140, or one or more processors in communication therewith, may request and receive weight information associated with the item from a database. Upon receiving the weight information associated with the item, the scan tunnel may request and receive a weight of the item from the weight sensor of the scan tunnel 140. The scan tunnel 140 may then compare the weight information received from the database and the weight information received from the weight sensor. If the weight information received from the database and weight information received from the weight sensor or are not within a predetermined error threshold, the scan tunnel 140 may assign an error designation to the item. In some embodiments, the error designation may indicate that the item or items had not been properly singulated.

In some embodiments, the scan tunnel 140 may be configured to determine a destination of an item traveling on the conveyor lane 120. The destination can be associated with the delivery point or location to which the item is to be delivered. In some embodiments, the destination can be a location in the sorter 150 associated with the delivery point. In some embodiments, the scan tunnel 140 may determine the destination of an item based on the item or delivery information received after scanning a label of the item. In some embodiments, the scan tunnel 140 may determine a destination of an item based on the type of item and whether the item has been assigned an error designation. In some embodiments, the scan tunnel 140 may determine a first destination for all items that are assigned an error designation. In some embodiments, the first destination may be a flatten and face area 170 of the relabeling system 160. In another embodiment, the scan tunnel 140 may determine a first destination for items that are assigned an error designation for not being singulated properly or for bag-type items that generated an error designation that only passed through the scan tunnel for a first time. In some embodiments, the scan tunnel 140 may be configured to determine a second destination for all other items that have been assigned an error designation. In this embodiment, the first destination may be a flatten and face area 170 of the relabeling system 160 and the second destination may be an item relabeling area 180 of the relabeling system 160. In some embodiments, all items which are assigned an error designation, or which generate a label error are directed to the relabeling system 160.

In some embodiments, the scan tunnel 140 is configured to identify the type of item passing through the scan tunnel 140, such as a letter, a flat, a package, a bag, a catalog, or a parcel, or the like. In some embodiments, the scan tunnel 140 upon scanning a label of an item may request and receive information related to the type of item from a database. In some embodiments, the scan tunnel 140 is configured to transmit the item-type information to a device further downstream from the scan tunnel 140. The device receiving the information may redirect the item based on the item-type information received. These devices are described in further detail below.

In some embodiments, the scan tunnel 140 is in wired or wireless communication with other parts of the system 100. In some embodiments, the scan tunnel 140 is configured to transmit a signal to the sorter 150, wherein the signal contains item or delivery information associated with a given item or wherein the signal identifies items that have generated a label error or have been assigned an error designation. In some embodiments, the signal contains a destination for an item as determined by the scan tunnel 140. In some embodiments, the scan tunnel 140 may be wired or wireless communication with a workstation of a flatten and face area 170 of the relabeling system 160. In some embodiments, the scan tunnel 140 may be configured to transmit item information (such as the type of item or whether the item or items have been properly singulated) to the sorter 150, the relabeling system 160 or other parts of the system 100.

In some embodiments, the scan tunnel 140 is configured to electronically or physically mark items that have generated a label error or have been assigned an error designation. In some embodiments, the electronic or physical mark is configured to be read and/or scanned by the scan tunnel 140, the sorter 150, the relabeling system 160 or other devices of the system 100. In some embodiments, upon scanning or reading the electronic or physical mark a device (such as the scan tunnel 140, the sorter 150, the relabeling system 160 or other devices) may receive information associated with the marked item. In some embodiments, the information may include the number of times the item has passed through the scan tunnel, the type of error designation (such as a singulation error designation, a label error designation, etc.). In this way, the electronic or physical marker may serve as an indicator of the number of times that an item has passed through the scan tunnel 140. In some embodiments, the scan tunnel 140 is configured to transmit information associated with the electronic or physical marker (including the number of times an item has passed through the scan tunnel 140) to other parts of the system for sorting items, for example when a device of the system scans or reads the electronic marker and/or requests the information.

In some embodiments, the scan tunnel 140 is configured to capture images of a label affixed to an item and/or at least one side of the item when the item and/or label is assigned an error designation.

The sorter 150 is located at a third position 126 on the conveyor lane. In some embodiments, the third position 126 may be at a location that is downstream from the automatic singulator 130 and the scan tunnel 140. The sorter 150 is configured to redirect items traveling along the conveyor lane 120. In some embodiments, the sorter 150 includes an actuation mechanism 152 that is configured to physically redirect items traveling along the conveyor lanes.

In some embodiments, the sorter 150 is a shoe sorter. In this embodiment, the actuation mechanism 152 may comprise a plurality of shoes. In some embodiments, when redirecting an item, the plurality of shoes may move across the conveyor lane 120 and form a barrier preventing an item from continuing to travel along the conveyor lane 120 in a first direction. In some embodiments, the barrier formed by the plurality of shoes directs the item to an adjacent or proximate path, such that the item travels in a second direction. In some embodiments, the adjacent or proximate path is a separate conveyor. In some embodiments, the sorter 150 may be located proximate a plurality of paths and the sorter 150 may be configured to direct items to different paths based on a signal or information received from the scan tunnel 140.

In some embodiments, the sorter 150 is configured to redirect items based on a signal and/or information received from the scan tunnel 140 or a processor. In some embodiments, the sorter 150 is configured to redirect items based on item or delivery information or a destination received from the scan tunnel 140. In some embodiments, the sorter 150 is configured to redirect items based on a delivery address associated with the item. In some embodiments, upon receiving a signal from the scan tunnel 140 identifying an item with a label error or an item that has been assigned an error designation, the sorter 150 is configured to redirect the items with a label error or that are assigned an error designation to the relabeling system 160. In some embodiments, the sorter 150 may be configured to direct all items with a label error or that are assigned an error designation to the flatten and face area 170.

Items that do not generate a label error in the scan tunnel 140 pass through the sorter 150 and into the downstream sortation portion (not shown) of the item processing equipment.

The flatten and face area 170 is located proximate the sorting system 110. The flatten and face area 170 includes an intake conveyor 172, a workstation 174, a reject conveyor 176 and a return conveyor 178. The intake conveyor 172 may be connected to the sorting system 110 and is located proximate the sorter 150. The intake conveyor 172 is configured to receive items redirected from the conveyor lanes 120 of the sorting system 110 and convey them to the workstation 174. In some embodiments, the sorter 150 may redirect items that are assigned an error designation for not being singulated properly and/or bag-type items that generated an error designation that only passed through the scan tunnel for a first time to the intake conveyor 172. In some embodiments, the sorter 150 may direct all items that have been assigned an error designation to the intake conveyor 172.

The workstation 174 is configured to receive items from the intake conveyor 172 and direct them to the reject conveyor 176 or the return conveyor 178. In some embodiments, an operator may be stationed at the workstation 174 and may receive the items coming from the intake conveyor 172. In some embodiments, the flatten and face area 170 may be fully automated.

In some embodiments, an operator stationed at the workstation 174 may singulate any nonsingulated items received from the intake conveyor 172 and place them on the return conveyor 178. In some embodiments, the operator may identify any bag-type items and determine if the bag has been folded such that part of the label is concealed or folded. If the bag-type item is folded, thus preventing the scan tunnel 140 from reading the label, the operator may flatten and unfold the bag-type item and place it on the return conveyor 178. In some embodiments, the operator may place other items and bags on the reject conveyor 176.

In some embodiments, the workstation 174 may be fully automated. In some embodiments, the workstation 174 may include at least one sensor configured to identify the type of item at the workstation 174 and to identify whether the item or items have been properly singulated. In some embodiments, the sensor may be at least one camera. In some embodiments, the workstation 174 may be in wired or wireless communication with the scan tunnel 140. In some embodiments, the workstation 174 may be configured to receive a signal from the scan tunnel 140 wherein the signal contains item information (such as what type of item it is, whether the item has been properly singulated, and/or the number of times an item has passed through the scan tunnel). In some embodiments, the workstation 174 may be configured to read or scan the physical or electronic mark made by the scan tunnel 140 and request and/or receive information associated with the marked item from the scan tunnel 140 or from other location, such as a database.

In some embodiments, the workstation 174 may include a workstation actuator 175. The workstation actuator 175 may be configured to singulate any non-singulated items arriving at the workstation 174. The workstation actuator 175 can be configured to reorient an item arriving at the workstation 174 on conveyor 172. The workstation actuator 175 can turn a package over using an automatic mechanism. In some embodiments, a camera at the workstation can identify a heigh or orientation of the item, and can cause the workstation actuator 175 to be placed in a position to turn a package over. Turning the package over can result in a face of the item which was not previously visible to the scan tunnel 140 being scannable. The workstation actuator 175 can rotate a parcel 90° or 180°, by, for example, lowering a mechanical device into a path of the item which impacts a surface of the item and causes the item to rotate and reorient. In some embodiments, the workstation actuator 175 can be a robotic arm able to manipulate the item to rotate and reorient the item. In some embodiments, the workstation actuator 175 can be a mechanical component controlled in cooperation with the intake conveyor 172 in order to turn an item over.

In some embodiments, the workstation 174 may include a flattening device configured to flatten any first-time bags arriving at workstation 174. In some embodiments, the workstation actuator 175 may additionally act as the flattening device.

In some embodiments, the workstation 174 may include a redirector. The redirector may be configured to redirect flattened first-time bags and items that have been singulated at the workstation 174 to the return conveyor 178. The redirector may be configured to redirect all other items to the reject conveyor 176. In some embodiments, the workstation actuator 175 may additionally serve as the redirector. Flattening the items may beneficially cause a label affixed to an item to become more visible and/or may remove any creases in the label preventing the scan tunnel 140 from reading it. This beneficially allows the scan tunnel 140 to read the affixed label.

The return conveyor 178 is connected to the workstation 174 and to at least one conveyor lane 120 of the sorting system 110. In some embodiments, the return conveyor 178 connects to the conveyor lane 120 at a fourth position 128. In some embodiments, the fourth position 128 may be located in between the automatic singulator 130 and the scan tunnel 140. In some embodiments the fourth position 128 may be located upstream of the automatic singulator 130. In some embodiments, the return conveyor 120 is connected to each of the plurality of conveyor lanes 120 in order to evenly distribute items returning from the relabeling system 160. Although only a single return conveyor 178 is depicted, the system 100 may comprise a return conveyor 178 connected to each individual lane 120, such that an item on the return conveyor 178 may be returned to any of the lanes 120. The return conveyor 178 may determine to which of the lanes 120 to return the items based on one or more characteristics of the item, the delivery information, or the available space on the lanes 120.

The reject conveyor 176 is connected to the workstation 174 and to an intake conveyor 182 of the item relabeling area 180 and is configured to convey items from the workstation 174 to the intake conveyor 182 of the item relabeling area 180.

FIG. 1B shows a top view of an item relabeling area 180. As seen in FIG. 1B, the item relabeling area 180 comprises the intake conveyor 182, a plurality of relabeling workstations 190, an exit conveyor 186 and a scanner 188.

The intake conveyor 182 is connected to the reject conveyor 176 of the flatten and face area 170 and is configured to receive items from the reject conveyor 176. In some embodiments, the intake conveyor 182 is connected to the at least one conveyor lanes 120 of the sorting system 110 and is configured to receive items directly or indirectly from the conveyor lanes 120. The sorters 150 may be configured to redirect items from any of the conveyor lanes 120 to the relabeling intake conveyor 182. The intake conveyor 182 is configured to receive items from the reject conveyor 176 and/or the conveyor lanes 120 and direct them to the plurality of relabeling workstations 190. In some embodiments, the intake conveyor 182 may include a plurality of actuators, such as shoe sorters, that direct items to the plurality of relabeling workstations 190.

Each relabeling workstation 190 is configured to receive items from the intake conveyor 182. An operator stationed at the relabeling workstation 190 or an automated relabeler 191 located at the relabeling workstation 190 will apply a new label to each item at the relabeling workstation 190. In some embodiments, the operator or automated relabeler 191 may apply a new label to a position on the item proximate the position of a previous label on the item. In some embodiments, the operator or the automated relabeler 191 may apply a new label to the same side of an item that has the previous label. When a label is damaged or cannot be read or scanned by the scan tunnel or other device, the operator or an automated reader can read the label and input the intended destination or delivery point, such as an address, into an interface at the relabeling workstation. The relabeling workstation 190 can generate a new label containing, for example, a computer readable code, which encodes or is associated with the intended delivery point for the item. In some embodiments, the relabeling workstation 190 generates a new label containing a number, each subsequent label generated by the relabeling workstation 190 containing the next number in a sequence. The automatic relabeler 191 applies the new label to the item.

In some embodiments, the relabeling workstation 190 comprises an automated system with additional or supplemental software for reading labels that returned a label error or that are associated with an error designation in the scan tunnel 140. The software may be more complicated or have greater processing power or algorithms to interpret the label on the item. In some embodiments, the scanners or cameras as the relabeling workstation 190 will have greater time allotted for reading and interpreting a code or label on an item, than the time allotted on one of the conveyor lanes 120 and the scan tunnel 140. In some embodiments, the workstation 190 receives the image of the item taken by the scan tunnel 140, and one or more processors in communication with the scan tunnel 140 and the relabeling workstation 190 begins the process of interpreting the damaged or undecipherable label while the item is rerouted by the sorter 150 and down the intake conveyor 182. This extra processing time may be sufficient for more advanced software or algorithms to decipher the label on the item. This extra processing time may not be available to process items on the conveyor lanes 120 and the scan tunnels 140, because those conveyors move too quickly and slowing them to process damaged or undecipherable labels would result in inefficiency or stopping of the sortation equipment.

After the item has been relabeled at the relabeling workstation 190, an actuator or operator may direct the item to the exit conveyor 186. The exit conveyor 186 is connected to the plurality of relabeling workstations 190 and the conveyor lane 120 of the sorting system 110 and is configured to receive items from the relabeling workstations 190. The exit conveyor 186 is configured to transport items that have been relabeled at the relabeling workstation 190 to the conveyor lane 120 of the sorting system 110 for reintroduction to the sorting stream and for reprocessing.

In some embodiments, a scanner 188 is located on the exit conveyor 186 at a position 181. The scanner 188 may be similar or identical to the scan tunnel 140 described above. The scanner 188 includes at least one sensor configured to scan and capture an image of the item traveling on the exit conveyor 186. In some embodiments, the at least one sensor may include at least one camera. In some embodiments, the scanner 188 is configured to capture an image of the label applied at the relabeling workstation 190. In some embodiments, the scanner 188 is additionally configured to capture an image of the previous label applied to the item. In some embodiments, the scanner 188 is configured to capture a single image of the item, the image containing both the new label applied at the relabeling station and the previous label. Capturing an image of the previous label is beneficial for a processor or operator when associating the item or delivery associated with the previous label with a new label as described in further detail below.

In some embodiments, the scanner 188 may be a six-sided scan tunnel configured to scan or capture images of all sides of an item traveling on the exit conveyor 186. In some embodiments, the scanner 188 is configured to scan a single side or less than all sides of an incoming items. In this embodiment, the scanner 188 may further include an actuator configured to rotate or orient items traveling through the scanner 188. In some embodiments, the actuator may be configured to orient an item in a first orientation such that a single or multiple sides can be scanned by the scanner 188 and/or such that the scanner 188 can capture an image of a single or multiple sides of the item. If the scanner 188 does not detect a label on the scanned sides of the item, the scanner 188 may send a signal to the actuator. In response to the signal received, the actuator may orient the item in a second orientation such that a different side or different sides are exposed to the scanner 188. This may continue until all sides of an item have been scanned or the scanner 188 detects a label on the item.

The scanner 188 is configured to transmit the captured image or images to a processing center where the images are processed. The processing center receives the captured image or images and associates the item or delivery information previously associated with the previous label with the new label. This process is described in further detail below.

After the image of the label is acquired and transmitted to the processing center, the exit conveyor 186 conveys the item back to the conveyor lanes 120 of the sorting system 110.

FIG. 1C shows an isometric view of a relabeling workstation 190. As seen in FIG. 1C, the relabeling workstation 190 includes an automatic relabeler 191, a chute 192, a buffer conveyor 193, a paddle 194, a plurality of gravity rollers 195, and a work surface 196.

The chute 192 is located at a first end 197 of the relabeling workstation 190. The chute 192 is connected to the intake conveyor 182 and is configured to receive items from the intake conveyor 182. Items that are redirected from the intake conveyor 182 and travel along the chute 192. In some embodiments, the intake conveyor 182 may be elevated relative to the relabeling workstation 190 such that the chute 192 is oriented at an angle. In some embodiments, the chute 192 is oriented at an angle such that items redirected from the intake conveyor 182 are propelled by gravity and travel down the chute 192. In some embodiments, the chute 192 is made of a metal or a material with a low coefficient of friction. This may be beneficial for allowing items to travel or slide down the chute 192.

The buffer conveyor 193 is connected the chute 192 at an opposite end from the intake conveyor 182. The buffer conveyor 193 is configured to receive items from the chute 192 and convey them to the gravity rollers 195. In some embodiments, the buffer conveyor 193 may be separated from the gravity rollers 195 by a paddle 194.

The paddle 194 may be positioned between the gravity rollers 195 and the buffer conveyor 193 and be configured to prevent items from exiting the buffer conveyor. In some embodiments, the paddle 194 may be configured to rotate or move between a first position and a second position. In a first position, the paddle 194 may be positioned such that items are prevented from moving between the buffer conveyor 193 and the gravity rollers 195. In the second position, the paddle 194 may be positioned such that items are free to move between the buffer conveyor 193 and the gravity rollers 195. In some embodiments, the paddle 194 comprises a component or protrusion that contacts a portion of an item to reorient or rotate the item as it moves between the buffer conveyor 193 and the workstation 196.

In some embodiments, the buffer conveyor 193 may include a sensor that monitors the number or amount of items present on the work surface 196. When the sensor senses that there are no items present on the work surface 196, the sensor may send a signal to the buffer conveyor 193. In response to the signal received, the buffer conveyor 193 may activate and convey an item to the gravity rollers 195. In some embodiments, the sensor may send a signal to the paddle 194. In response to the signal received, the paddle 194 may rotate to a second position such that it no longer prevents items from moving between the buffer conveyor 193 and the gravity rollers 195.

The gravity rollers 195 are located in between the buffer conveyor 193 and the work surface 196. In some embodiments, the gravity rollers 195 comprise rollers or other objects that are configured to rotate as a horizontal or parallel force is applied to the rollers or object. In some embodiments, the work surface 196 is positioned at a lower elevation relative to the buffer conveyor 193. In this embodiment, the gravity rollers 195 may positioned at an angle such that items leaving the buffer conveyor 193 are propelled by gravity down the gravity rollers 195. The items propelled by gravity then arrive at the work surface 196.

In some embodiments, an operator may be stationed at the work surface 196. The operator may receive items from the buffer conveyor 193 and apply a new label to the item. In some embodiments, the operator may apply the new label to a same side of the item that has the previous label. After the item has been labeled, the operator may place the item on the exit conveyor 186.

In some embodiments, an automated relabeler 191 may be positioned proximate the work surface 196 or may be connected to the work surface 196. The automated relabeler 191 is configured to receive items from the buffer conveyor 193 and apply a new label to them. In some embodiments, the automated relabeler 191 may include at least one sensor. The sensor may be configured to sense whether an exposed side or sides of an items contains a previously applied label. In some embodiments, the sensor may be configured to scan of all sides of an item and determine which side contains a previously applied label. In some embodiments, the sensor is configured to scan a single side or less than all sides of an item. In this embodiment, the automated relabeler 191 may further include an actuator configured to rotate or orient items on the work surface 196. In some embodiments, the actuator may be configured to orient an item in a first orientation such that a single or multiple sides can be scanned by the sensor. If the sensor does not detect a label on the scanned sides of the item, the sensor may send a signal to the actuator. In response to the signal received, the actuator may orient the item in a second orientation such that a different side or different sides are exposed to the sensor. This may continue until all sides of an item have been scanned or the sensor detects a label on the item.

After the sensor has detected a side of the item that contains a label, the automated relabeler 191 is configured to apply a new label to the item. In some embodiments, the automated relabeler 191 is configured to apply a new label to the item on the same side of the item that contained the previous label. In some embodiments, the automated relabeler 191 is configured to apply a new label to the item such that the previous label is not covered or obstructed by the new label. In some embodiments, the new label comprises a computer readable code which is does not correspond to or is not associated with a delivery point or delivery information. The new label can be associated with the delivery point or delivery information at a later time.

In some embodiments, the new label comprises the delivery point or is associated with the delivery information, if, for example, the system is able to identify the delivery point or read a label using the additional time and processing resources available as the item moves along the intake conveyor 182. If the label and/or code on an item is identified at a point after the item passes through the scan tunnel 140 and is assigned an error designation, the code on the label can be programmed to encode the delivery information or be associated with the delivery information.

In some embodiments, the automated relabeler 191 may include a redirector. Once a new label is applied to the item, the redirector is configured to move the item to the exit conveyor 186.

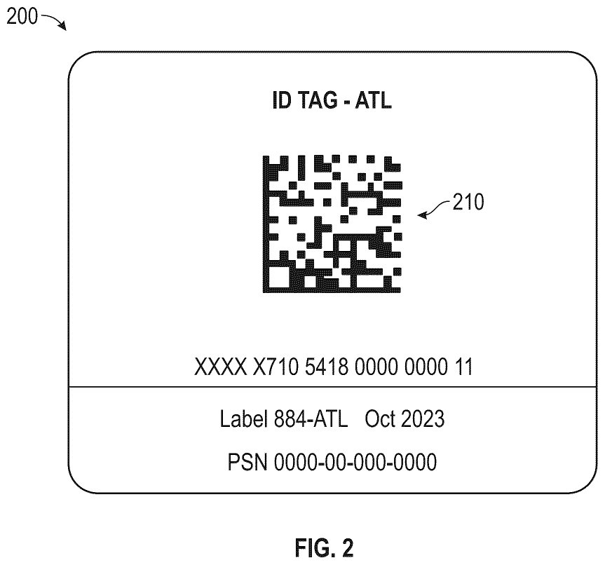

FIG. 2 shows an example embodiment of a label 200. In some embodiments, the label 200 is the new label applied to an item by the automated relabeler 191 described herein or by an operator. In some embodiments, the new label 200 has a smaller footprint than the previous label affixed to an item.

The new label 200 includes a scannable portion 210. In some embodiments, the scannable portion may be a QR code, a bar code, or other type of computer readable code. The scannable portion 210 of the new label is configured to be scanned by a scan tunnel or scanner as described herein. Upon scanning the scannable portion 210 of the new label 200, the scan tunnel 140 or scanner 188 receives information associated with the new label from a database.

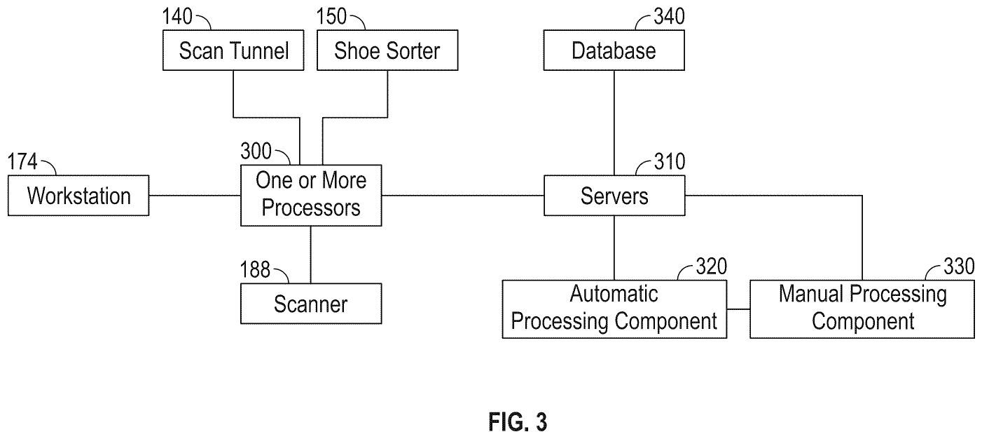

FIG. 3 is a block diagram schematically illustrating various components of the system 100 of FIGS. 1A-1C. The system 100 includes a one or more processors 300 which can be used in autonomously controlling the operation of the system 100. The one or more processors 300 may include one or more controllers, integrated circuits, field-programmable gate array or any other suitable control circuitry. In one embodiment, the one or more processors 300 includes a Raspberry Pi system. In some embodiments, the one or more processors 300 includes or is in communication with a local area communications module and a wide area communications module. The local area communications module may include one or more transceivers able to communicate via Bluetooth, Wi-Fi, or any other suitable local area communication protocol with local devices, such as a scan tunnel, shoe sorter, or a workstation as described in greater detail elsewhere herein. The wide-area communications module may include one or more transceivers able to communicate via 4G, 5G, Edge or any other suitable wide area communication protocol with external devices, including remote devices such as cloud servers or other network entities.

Furthermore, each of the components as seen in FIG. 3 or described elsewhere herein may include one or more processors associated with each individual component and used for autonomously controlling each component of FIG. 3. The one or more processors 300 may be in wired or wireless communication with each of the processors associated with the components rather than the components themselves.

As can be seen in FIG. 3, the one or more processors 300 are in communication with various components of the system 100, including the scan tunnel 140 and sensors of the scan tunnel 140, such as a camera or weight sensor. The communication between the one or more processors 300 and the scan tunnel 140 may be wired or wireless. The scan tunnel may be configured to transmit information to the one or more processors 300. In some embodiments, information is transmitted to the one or more processors 300 in response to a signal received by the scan tunnel 140. The information from the scan tunnel 140 may include the destination of an item determined by the scan tunnel 140 in communication with one or more memories or database 340, the type of an item passing through the scan tunnel 140, the number of times an item has passed through the scan tunnel, whether the item or items have been properly singulated and/or whether an item traveling through the scan tunnel generated a label error or was assigned and an error designation. The scan tunnel 140 may be configured to request information from the one or more processors 300 by sending a signal to the one or more processors 300. In some embodiments, the one or more processors 300 may transmit information to the scan tunnel 140 without receiving a signal from the scan tunnel 140. In some embodiments, when the scan tunnel 140 scans the label of an item, it may send a signal to the one or more processors 300 requesting any item or delivery information associated with the scanned label. In some embodiments, the item or delivery information includes a delivery name and/or address, a requested or estimated date of delivery, sender name and/or address, weight of the item, type of item, such as an envelope, a package, or a bag, and/or other information. Upon sending a signal to the one or more processors 300, the scan tunnel 140 may receive the associated item or delivery information from the one or more processors 300.

The one or more processors 300 is also in communication with the sorter 150 and sensors associated with the sorter 150. The communication between the one or more processors 300 and the sorter 150 may be wired or wireless. The sorter 150 may be configured to request information from the one or more processors 300 by sending a signal to the one or more processors 300. In some embodiments, the workstation 174 may request information from the one or more processors 300 after scanning or reading the electronic or physical mark on an item. In some embodiments, when an item arrives at the sorter 150, the sorter 150 may send a signal to the one or more processors 300. In response to the signal received, the one or more processors 300 may transmit information to the sorter 150. In some embodiments, the one or more processors 300 may transmit information to the sorter 150 without receiving a signal from the sorter 150. In some embodiments, the information transmitted to the sorter 150 includes the destination of the item as determined by the scan tunnel 140, the type of item at the sorter 150, whether the item generated a label error or was assigned an error designation when scanned at the scan tunnel 140, and/or item or delivery information associated with the item. In response to the information received from the one or more processors 300, the sorter 150 may redirect the item based on the information received. In some embodiments, when the sorter 150 receives an item that did not generate a label error, the sorter 150 may direct that item into a downstream sortation portion of the system 100. In some embodiments, when the sorter 150 receives information that an item has generated a label error, the sorter 150 directs that item to a relabeling system.

The one or more processors 300 is also in communication with the workstation 174 and any sensors or components associated with the sorter workstation 174. The communication between the one or more processors 300 and the workstation 174 may be wired or wireless. The workstation 174 may be configured to request information from the one or more processors 300 by sending a signal to the one or more processors 300. Upon receiving a signal from the workstation 174, the one or more processors 300 may transmit the requested information to the workstation 174. In some embodiments, the workstation 174 may request information from the one or more processors 300 after scanning or reading the electronic or physical mark on an item. In some embodiments, the one or more processors 300 may transmit information to the workstation 174 without receiving a signal from the workstation 174. In some embodiments, the information received by the workstation 174 includes the type of item arriving at the workstation, whether the item has been singulated and/or the number of times that said item has passed through the scan tunnel. In some embodiments, the workstation 174 is configured to redirect the items, via the actuator, arriving at the workstation based on the information received. In some embodiments, the workstation 174 may receive information from the one or more processors 300 that an item hasn't been singulated properly or is a first-time bag. In response to the information received, the actuator of the workstation 174 may singulate the item or flatten the first-time bag and a redirector of the workstation 174 may redirect the item or bag to the return conveyor 178, which carries the item or bag back to the at least one conveyor lane 120.

The one or more processors 300 is also in communication with the scanner 188 and any sensors or components associated with the scanner 188. The communication between the one or more processors 300 and the scanner 188 may be wired or wireless. In some embodiments, the scanner 188 is configured to transmit information to receive information from the one or more processors 300. In some embodiments, the scanner 188 transmits information to the one or more processors 300 based on a signal received from the one or more processors 300. In some embodiments, the scanner 188 transmits to one or more processors 300 without receiving a signal from the one or more processors 300. In some embodiments, the scanner 188 transmits an image or images of a previous label and a new label captured by a camera of the scanner 188.

The one or more processors 300 may be in communication with one or more servers 310. The communication between the one or more processors 300 and the server 310 may be wired or wireless. The server 310 may be located on-site relative to the system 100 or may be located off-site relative to the system 100. The server 310 may be configured to receive information from and transmit information to the one or more processors 300. In some embodiments, the one or more processors 300 may transmit images of the previous and new labels received from the scanner 188 to the server 310. In some embodiments, the server 310 may transmit item or delivery information associated with a new label or previous label to the one or more processors 300.

The server 310 may be in communication with an automatic processing component or center 320. The communication between the server 310 and the automatic processing component 320 may be wired or wireless. The server 310 is configured to transmit images of previous and new labels received from the one or more processors 300 to the automatic processing component 320. Upon receiving an image or images from the server 310, the automatic processing component 320 attempts to conduct optical character recognition (OCR) on the image. In some embodiments, the automatic processing component 320 analyzes the image and attempts to convert text containing item or delivery information from the previous label on the item into machine-readable text data. In some embodiments, the item or delivery information may include a delivery address, sender address, weight of the item, or other information. If the automatic processing component 320 is able to successfully convert information from the image or images received into machine-readable text data, the automatic processing center 320 may associate the converted information with the new label present in the image or images received, such that when a device scans the new label, the device is able to request and receive and/or access the converted information associated with the label. Upon successfully associating the information with the new label, the automatic processing component 320 is configured to transmit the associated information and result of the OCR to the server 310. If the automatic processing component is unable to successfully convert the information into text, the automatic processing component 320 may transmit the images to a manual processing component 330 via a wired or wireless communication.

The manual processing component 330 is in communication with the automatic processing component and the one or more servers 310. The communication between the manual processing component and the server 310 and the automatic processing component 320 may be wired or wireless. The manual processing component 330 is configured to receive images from the automatic processing component 320. The manual processing component 330 includes operators. After receiving the image or images from the automatic processing center 320, a operator may manually view the images and convert the information in the images into a computer readable or machine-readable format, such as text. Once the information has been converted, the manual processing component 330 associates the converted information with the new label present in the one or more images received. The manual processing component 330 is then configured to transmit the associated information to the server 310, which in turn may transmit the information to a database 340.

The database 340 is in communication with the server 310. The communication between the database 340 and the server 310 may be wired or wireless. The database in configured to store information received from the server 310 or from other locations. In some embodiments, the database is configured to receive the converted information that is associated with a new label from the server 310 and store the information within the database. The database 340 is configured to transmit data to the one or more servers 310 based on a signal received from the one or more servers 310. In some embodiments, the server 310 may receive a request from the one or more processors 300 for information associated with a label affixed to an item. The server 310 in turn may send a signal to the database 340 requesting the information. The database then transmits the information to the server 310, which in turn, transmits the information to the one or more processors 300 for further transmission to other components of the system 100.

In some embodiments, the one or more processors 300 and the server 310 may be part of the same component, or may be separate components. In some embodiments, the one or more processors 300 and the server 310 can be the same component and provide all the functionality described herein.

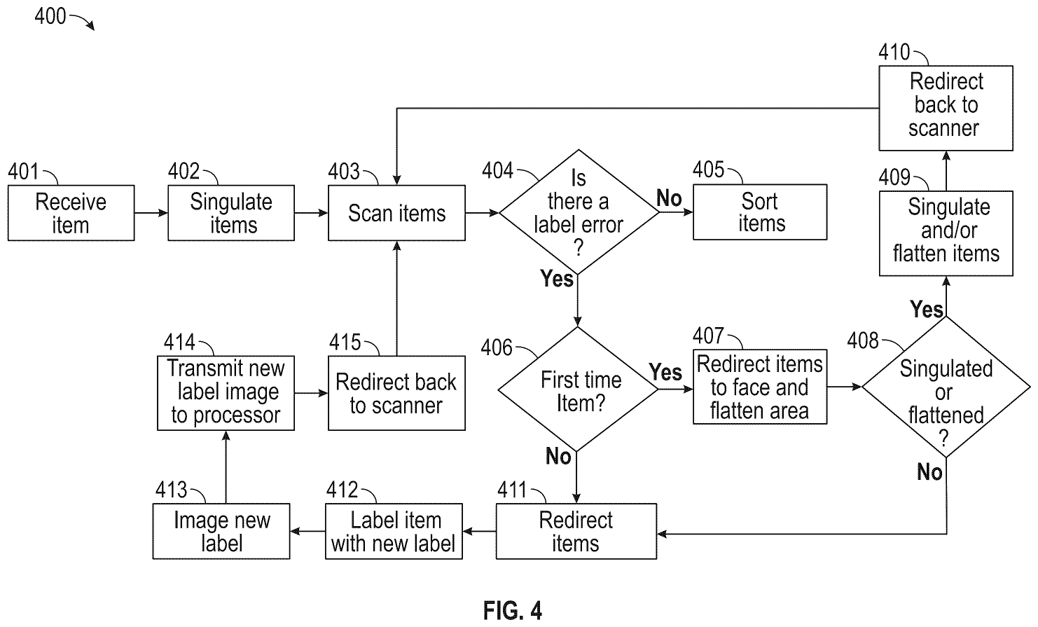

FIG. 4 shows a block diagram of a process for relabeling an item using systems and methods described herein. A process 400 starts with block 401 where the sorting system or apparatus receives an item or a plurality of items. In some embodiments, the system receives items to be sorted or processed, and traveling on a conveyor lane, such as the conveyor lane 120.

The process 400 moves to block 402, wherein the items traveling on the conveyor lane are singulated by an automatic singulator, such as the singulator 130, such that there is a desired amount of space in between each item traveling on the conveyor lane.

The process 400 moves to block 403, wherein the items pass through and are scanned by a scan tunnel as described herein, such as scan tunnel 140. In some embodiments, the scan tunnel includes cameras that scan the items traveling on the conveyor lane. In some embodiments, the scan tunnel may be a six-sided tunnel that scans every side of an item traveling on the conveyor lane. In some embodiments, the scan tunnel reads a label on the item. Upon scanning the label, the scan tunnel may receive delivery or item location associated with the label from a database.

The process 400 moves to decision state 404, wherein the scan tunnel determines whether to assign an error designation to the scanned item or to generate a label error. In some embodiments, the scan tunnel may assign an error designation to a scanned item or to generate a label error when the scan tunnel is unable to locate a label on the item. In some embodiments, the scan tunnel may assign an error designation to a scanned item or to generate a label error when the scan is unable to scan or read a label on an item. In some embodiments, the scan tunnel may assign an error designation to a scanned item or to generate a label error when the scan tunnel is determines that an item or a plurality of items have not been properly singulated.

If in decision state 404 the scan tunnel determines that a label error or an error designation need not be associated with the scanned item, the process 400 proceeds to block 405, the item is allowed to continue along the conveyor lane and is sorted further downstream based on the item or delivery information that was received by the scan tunnel. In some embodiments, the items are sorted based on a delivery location of the item.

If the scan tunnel determines in decision state 404 that a label error has occurred or that a scanned item has an error designation associated with it, process 400 moves to decision state 406, wherein it is determined whether the item with the label error and/or error designation is a bag passing through the scan tunnel for the first time or if it is a non-singulated item. In some embodiments, the scan tunnel marks items with an indication of a label error or with an indication of an error designation physically or electronically. The scan tunnel is configured to read or scan the electronic or physical mark and determine the number of times that the mark has passed through the scan tunnel.

In decision state 406, the scan tunnel determines whether the item with the label error is a bag-type item passing though the scan tunnel for the first time or if it is a non-singulated item. In some embodiments, the scan tunnel is configured to determine the number of times the item has passed through the scan tunnel by detecting or identifying, for example, a mark on the item and/or the type of item passing through the scan tunnel, such as a letters, flats, bags, packages, magazines, catalogs, and parcels.

In some embodiments, when the scan tunnel determines that a bag has a label error or an error designation, it will check to see how many times this bag has passed through the scan tunnel by checking to see if the electronic or physical mark has passed through the scan tunnel previously. If the mark has not passed through the scan tunnel previously, the scan tunnel may provide an indication that the item is a bag passing through the scan tunnel for the first time. In some embodiments, the scan tunnel is further configured to determine if an item with a label error or error designation has been properly singulated. In some embodiments, the scan tunnel determines that an item has not been properly singulated via a weight sensor. In some embodiments, the item may have a label attached to the item that when scanned provides the scan tunnel with weight information regarding the item. In some embodiments, if the weight information generated by the weight sensor is not the same as the weight information associated with the label, the scan tunnel may identify that item or set of items as non singulated. In some embodiments, a camera of the scan tunnel is configured to determine whether an item or set of items has been properly singulated.

If, in decision state 406 the scan tunnel determines that an item with a label error or error designation is began item passing through the scan tunnel for a first time or a nonsingulated item, the process 400 proceeds to block 407 wherein the items are redirected. If in decision state 406 the scan tunnel determines that the item with the label error or error designation is not a first time item, the process 400 proceeds to block 411. In some embodiments, decision state 406 can be optionally performed or omitted.

In block 407, the item is directed, via a sorter, such as the sorter 150, to a flatten and face area, such as the flatten and face area 170. In some embodiments, the scan tunnel is configured to transmit a signal to the sorter indicating that the item is to be redirected to the flatten and face area.

The process 400 moves to decision state 408, wherein the item arrives at the flatten and face area for processing and it is determined whether the item can be singulated or flattened. An operator or an automated workstation can make the determination whether the item can be singulated or if it can be flattened. In some embodiments, an operator is stationed at the flatten and face area. The operator receives the item and determines if it can be singulated or flattened. In some instances, a label may be covered by a bag folded in on itself. The covered label may have caused the scan tunnel to generate a label error or assign an error designation when scanning said item.

If the operator or automated workstation determines that the item can be singulated or flattened, the process 400 proceeds to block 409, wherein the item(s) are singulated or flattened.

In block 409, the operator or automated workstation flattens said item such that the label is no longer covered or singulates any items that have not been properly singulated. The process then moves to block 410, wherein the items are redirected by to conveyor to a location upstream the scan tunnel. The process 400 then returns to block 403.

If, in decision state 408 it is determined that the item cannot be singulated or flattened or that singulating or flattening the item would not resolve the error designation, the process 400 moves to block 411, wherein the items from the flatten or face area or from the conveyor lane are redirected to the item relabeling area. In some embodiments, a sorter redirects the items from the conveyor lane to the item relabeling area. In some embodiments, the shoe sorter receives a signal from the scan tunnel identifying an item to be redirected. Upon receiving the signal, the shoe shorter may redirect the item to the item relabeling area. In some embodiments, an operator at a the flatten or face area redirects items to the item relabeling area. In some embodiments, the flatten and face area includes an automated workstation that redirects the items to the item relabeling area.

The process 400 moves to block 412, wherein the item is provided with a new label at the item relabeling area. In some embodiments, the item relabeling area includes a relabeling workstation where an operator is stationed. The operator may receive the item and orient the item such that the previous label is in a certain orientation. The operator may then apply a new label to the item. In some embodiments, the operator may apply a new label to the item at a location near the previous label. In some embodiments, the workstation includes a labeling machine. In some embodiments, after the operator has received the item and oriented it appropriately, the operator may apply the label, via the labeling machine. The new label, when applied to the item, may not have any information associated with it. As described in greater detail below, the information associated with the previous label is associated with the new label at a automatic processing component or manual processing component described in greater detail below. In some embodiments, the new label may be similar to the label 200 as seen in FIG. 2. In some embodiments, the new label may include a QR code, a bar code, or similar scannable feature that is configured to be scanned by a scan tunnel or scanner as described herein.

In some embodiments, the relabeling area is automated. In some embodiments, the relabeling area may receive a packaged to be relabeled. After the item has been received, the relabeling area may reorient the item, via an actuator, such that the item can be properly relabeled. After the relabeling area has oriented the item, an automated relabeler may apply a new label to the item. In some embodiments, the new label is applied to the same side of the item that the previous label is located.

The process 400 moves to block 413, wherein, after the item has been relabeled, an image of the new label and an image of the previous label is taken. In some embodiments, a single image of the new label alongside the previous label is taken. In some embodiments, the image of the new label is taken at a scanner, such as the scanner 188. After the item has been relabeled, the operator or the automated relabeling area may place the item on a conveyor leading to a scanner. The scanner may include a camera and/or sensor that images the item as it travels on the conveyor.

In some embodiments, an image of the new label is captured at the relabeling workstation of the item relabeling area. In some embodiments, the relabeling workstation includes a camera that can be operated automatically or by the operator. After the item has been relabeled, the camera may capture an image of the new label and an image of the previous label. In some embodiments, the camera may capture a single image of the new label alongside the previous label.

The process 400 moves to block 414, wherein image of the new label and the previous label is transmitted to a processing center to be processed. The processing center receives the image and associates the item information and/or delivery information associated with the previous label with the new label.

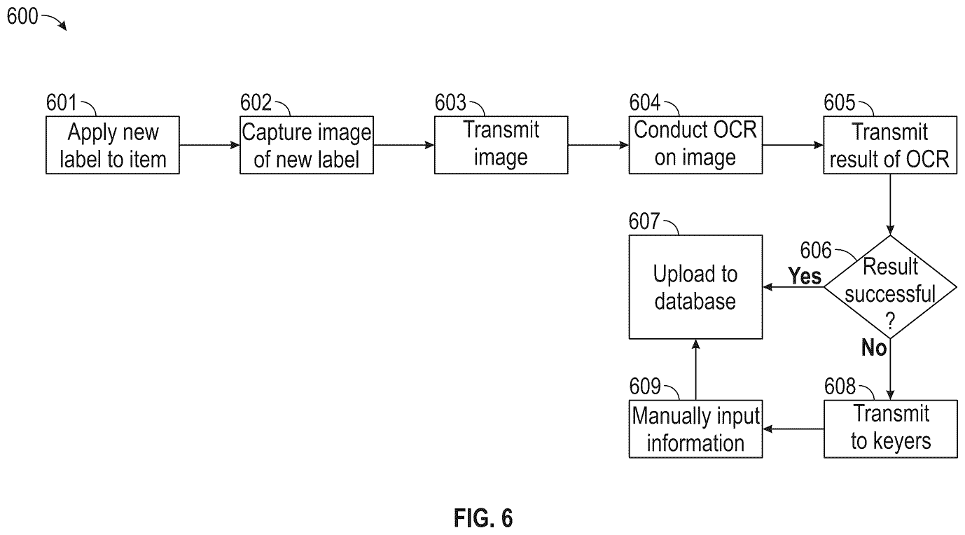

The process associated with blocks 412, 413, and 414 of process 400 are discussed in greater detail below in connection with FIG. 6.

The process 400 moves to block 415, wherein the item is redirected back to the conveyor lane with the scan tunnel, and the process 400 returns to block 403. The process 400 can be performed for each item that is to be sorted or processed on the sorting equipment. The processes here can be performed under the control of one or more processors in communication with one or more memories, databases, controllers, and the like.

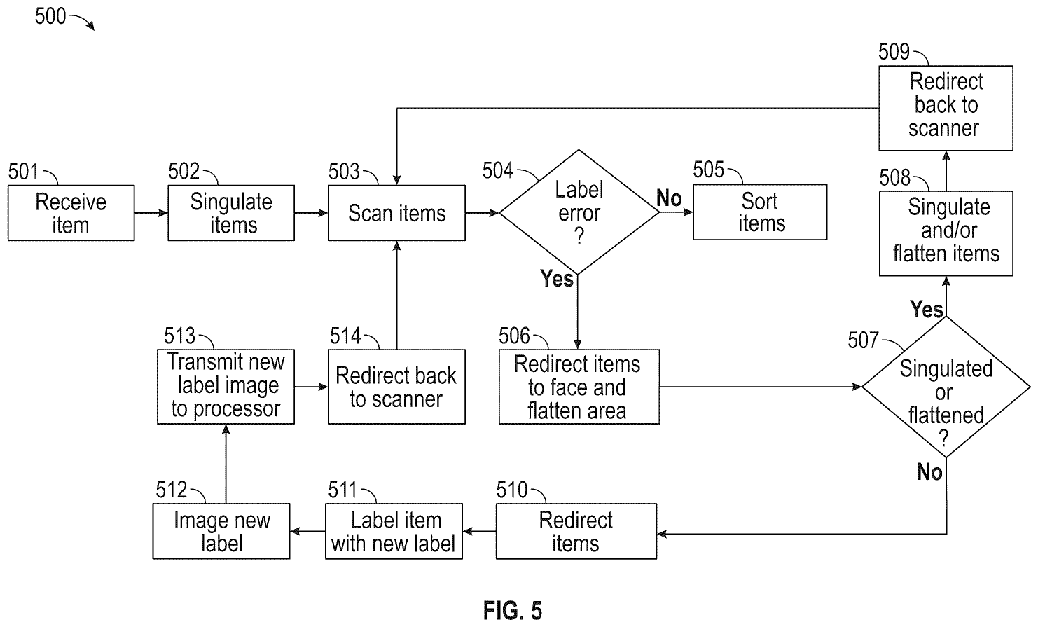

FIG. 5 is a process for relabeling an item using a relabeling system described herein. In many respects the process seen in FIG. 5 may be similar to those described elsewhere herein.

A process 500 starts with block 501 where the system receives an item. In some embodiments, the system receives items traveling on a conveyor lane. The process 500 moves to block 502, wherein the items are singulated by an automatic singulator.

The process 500 moves to block 503, the items are scanned by a scan tunnel as described herein. In some embodiments, the scan tunnel includes cameras that scan the items traveling on the conveyor lane. In some embodiments, the scan tunnel may be a six-sided tunnel that scans every side of an item traveling on the conveyor lane. In some embodiments, the scan tunnel reads a label on the item. Upon scanning the label, the scan tunnel may receive delivery or item location associated with the label from a database.

The process 500 moves to decision state 504, wherein the scan tunnel determines whether to assign an error designation to the scanned item or to generate a label error. In some embodiments, the scan tunnel may assign an error designation or a label error to an item when the scan tunnel is unable to locate a label on the item. In some embodiments, the scan tunnel may assign an error designation or a label error to an item if the scan is unable to scan or read a label on an item. In some embodiments, the scan tunnel may assign an error designation or a label error to an item when the scan tunnel is determines that an item or a plurality of items have not been properly singulated.

If in decision state 504 the scan tunnel determines that a label error or an error designation need not be assigned to an item, the process 500 proceeds to block 505, wherein the item is sorted further downstream based on the item or delivery information that was received by the scan tunnel. In some embodiments, the items are sorted based on a delivery location of the item.

If the scan tunnel determines in decision state 504 that a label error has occurred, the process 500 proceeds to block 506, wherein the item that generated the label error is directed, via a shoe sorter, to a flatten and face area. In some embodiments, the scan tunnel is configured to transmit a signal to the shoe sorter indicating that the item is to be redirected to the flatten and face area. In some embodiments, the scan tunnel marks items with a label error physically or electronically. The scan tunnel is configured to count the number of times that the mark has passed through the scan tunnel.

The process 500 proceeds to block 507, wherein the item arrives at the flatten and face area for processing and it is determined whether the item can be singulated or flattened. An operator or an automated workstation then can make the determination whether the item can be singulated or if it can be flattened. In some embodiments, an operator is stationed at the flatten and face area. The operator receives the item and determines if it can be singulated or flattened. In some embodiments, a label may be covered by a bag folded in on itself. The covered label may have caused the scan tunnel to generate a label error when scanning said item.

If the operator or automated workstation determines that the item can be singulated or flattened, the process 500 proceeds to block 508 wherein the operator or automated workstation flattens said item such that the label is no longer covered or singulates any items that haven't been properly singulated. The process 500 proceeds to block 509, wherein once the items have singulated or flatten the items are redirected by to conveyor to a location upstream the scan tunnel and the process proceeds to block 503.

If in decision state 507, it is determined that the item cannot be singulated or flattened, the process 500 proceeds to block 510, wherein the items from the flatten or face area or from the conveyor lane are redirected to the item relabeling area. In some embodiments, a sorter redirects the items from the conveyor lane to the item relabeling area. In some embodiments, the sorter receives a signal from the scan tunnel identifying an item to be redirected. Upon receiving the signal, the shorter may redirect the item to the item relabeling area. In some embodiments, an operator at a the flatten or face area redirects items to the relabeling area. In some embodiments, the flatten and face area includes an automated system that redirects the items to the item relabeling area.

The process 500 proceeds to block 511, wherein the item is provided with a new label at the item relabeling area. In some embodiments, the item relabeling area includes a relabeling workstation where an operator is stationed. The operator may receive the item and orient the item such that the previous label is in a certain orientation. The operator may then apply a new label to the item. In some embodiments, the operator may apply a new label to the item at a location near the previous label. In some embodiments, the relabeling workstation includes a labeling machine. In some embodiments, after the operator has received the item and oriented it appropriately, the operator may apply the label, via the labeling machine.

In some embodiments, the relabeling workstation is automated. In some embodiments, the relabeling workstation may receive an item to be relabeled. After the item has been received, the relabeling workstation may reorient the item, via an actuator, such that the item can be properly relabeled. After the relabeling workstation has oriented the item, an automated relabeler may apply a new label to the item. In some embodiments, the new label is applied to the same side of the item that the previous label is located.

The process 500 moves to block 512, wherein an image of the new label and an image of the previous label is taken. In some embodiments, a single image of the new label alongside the previous label is taken. In some embodiments, the image of the new label is taken at a scanner, such as the scanner 188. After the item has been relabeled, the operator or an actuator of the automated relabeler may place the item on a conveyor leading to a scanner. The scanner may include a camera that images the item as it travels on the conveyor.

In some embodiments, an image of the new label is captured at the relabeling workstation. In some embodiments, the relabeling workstation includes a camera that can be operated automatically or by the operator. After the item has been relabeled, the camera may capture an image of the new label and an image of the previous label. In some embodiments, the camera may capture a single image of the new label alongside the previous label.

The process 500 moves to block 513 wherein the image of the new label and the previous label is transmitted to a processing center to be processed. The processing center receives the image and associates the item information and/or delivery information associated with the previous label with the new label.

The process associated with blocks 511, 512, and 513 of process 500 are discussed in greater detail below in connection with FIG. 6.

The process 500 proceeds to block 514, the item is redirected back to the conveyor lane with the first scan tunnel. The process 500 returns to block 503. The process 500 can be performed for each item that is to be sorted or processed on the sorting equipment. The processes here can be performed under the control of one or more processors in communication with one or more memories, databases, controllers, and the like.

FIG. 6 shows a process 600 for associating information from a previous label with a new label. The process 600 describes in greater detail the blocks 412, 413, and 414 of process 400 and blocks 511, 512, and 513 of process 500. The process 600 begins with block 601 where a new label is applied to an item with a missing or unreadable label. In some embodiments, block 601 may be similar or identical in many respects to blocks 412 and 511 of FIGS. 4 and 5 respectively.

The process 600 proceeds to block 602, wherein an image of the new label is captured. In some embodiments, block 602 may be similar or identical in many respects to blocks 413 and 512 of FIGS. 4 and 5 respectively.

The process 600 moves to block 603, wherein the image is transmitted for processing. In some embodiments, the image is first transmitted to a software component. After the image is transmitted or uploaded to the software, the image is further transmitted to an image processing system. The image processing system can be part of the sorting apparatus, or can be remotely located and have a communicating connection with one or more processors controlling operation of the sorting apparatus. In some embodiments, the image processing system may include an automatic processing component, a manual processing component, and a server. In some embodiments, the image is transmitted to the server, which then transmits the image to the automatic processing component. In some embodiments, the image is transmitted directly to the image processing system from the scanner.

The process 600 moves to block 604, wherein the automatic processing component attempts to conduct image analysis such as optical character recognition (OCR) or other image recognition process on the image. In some embodiments, the automatic processing component analyzes the image and attempts to convert text containing item or delivery information from the previous label on the item into a machine-readable format or to identify a delivery point, or read a computer readable code, from the image. In some embodiments, the item or delivery information may include a delivery address, sender address, weight of the item, or other information. In some embodiments, the automatic processing component can be the scanner 140 as described elsewhere herein, or can be one or more other components, such as the one or more processors, that interpreted or analyzed the image using more processing power and/or more processing time provided as the item moved within the relabelling portion of the system.

The process 600 moves to block 605, the result of the image analysis, such as a delivery point, of the automatic processing component is transmitted back to the server. The process 600 proceeds to decision state 606, wherein the sever receives the result of the image analysis from the automatic processing component and determines whether the result was successful. If the server receives an indication that the result of the image analysis was a failure, the process 600 proceeds to block 608, wherein the image is transmitted to the manual processing component for further processing.

The process proceeds to block 609, wherein the manual processing component receives the image. An operator views the image and manually inputs the text information, which may include item or delivery information, from the previous label into the system. After the text information is manually inputted, the image and associated information are transmitted back to the server and the process 600 proceeds to block 607 described below.

If in decision block 606, it is determined that the result is successful, the process 600 proceeds to block 607. In block 607, the system associates the delivery information from the analyzed label or from the manual processing component with the new label provided on the item. The the image of the new label and associated item or delivery information from the previous label are associated together and are uploaded to a database. The process 600 then ends.

Various illustrative logics, logical blocks, modules, circuits and algorithm steps described in connection with the implementations disclosed herein may be implemented as electronic hardware, computer software, or combinations of both using one or more processors, controllers, circuits, and the like. The interchangeability of hardware and software has been described generally, in terms of functionality, and illustrated in the various illustrative components, blocks, modules, circuits, and steps described above. Whether such functionality is implemented in hardware or software depends upon the particular application and design constraints imposed on the overall system.

In one or more aspects, the functions described herein may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, e.g., one or more modules of computer program instructions, encoded on a computer storage media for execution by, or to control the operation of, data processing apparatus.

If implemented in software, the functions may be stored on or transmitted over as one or more instructions or code on a computer-readable storage medium. The steps of a method or algorithm disclosed herein may be implemented in a processor-executable software module which may reside on a computer-readable storage medium. Computer-readable storage media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above can also be included within the scope of computer-readable storage media. Additionally, the operations of a method or algorithm may reside as one or any combination or set of codes and instructions on a machine readable storage medium and computer-readable storage medium, which may be incorporated into a computer program product.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Components from different embodiments are specifically contemplated to be combinable with each other. Those of skill in the art will understand that various components from different figures, methods, and embodiments can be combined without departing from the scope of this application.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Instructions refer to computer-implemented steps for processing information in the system. Instructions can be implemented in software, firmware or hardware and include any type of programmed step undertaken by components of the system.

As can be appreciated by one of ordinary skill in the art, each of the modules of the invention may comprise various sub-routines, procedures, definitional statements, and macros. Each of the modules are typically separately compiled and linked into a single executable program. Therefore, the description of each of the modules is used for convenience to describe the functionality of the system. Thus, the processes that are undergone by each of the modules may be arbitrarily redistributed to one of the other modules, combined together in a single module, or made available in a shareable dynamic link library. Further, each of the modules could be implemented in hardware. A person of skill in the art will understand that the functions and operations of the electrical, electronic, and computer components described herein can be carried out automatically according to interactions between components without the need for user interaction.

The foregoing description details certain embodiments. It will be appreciated, however, that no matter how detailed the foregoing appears in text, the development may be practiced in many ways. It should be noted that the use of particular terminology when describing certain features or aspects of the development should not be taken to imply that the terminology is being re-defined herein to be restricted to including any specific characteristics of the features or aspects of the development with which that terminology is associated.

While the above detailed description has shown, described, and pointed out novel features of the development as applied to various embodiments, it will be understood that various omissions, substitutions, and changes in the form and details of the device or process illustrated may be made by those skilled in the technology without departing from the intent of the development. The scope of the development is indicated by the appended claims rather than by the foregoing description. All changes which come within the meaning and range of equivalency of the claims are to be embraced within their scope.

What is claimed is:

1. A method for processing items, the method comprising:
receiving, in a sorting system, an item, the sorting system comprising a scanner;
scanning, by the scanner, a label on an item;
assigning an error designation to the item based on the scanning;
automatically redirecting the item to a relabeling component within the sorting system based on the assigned error designation;
applying a new label to the item;
receiving delivery information for the item; and
associating the delivery information with the new label.

2. The method of claim 1, further comprising prior to scanning a label on an item, singulating the items, via an automatic singulator.

3. The method of claim 1, wherein assigning the error designation to the item comprises determining, by the scanner, that the label cannot be fully read.

4. The method of claim 3, wherein determining that the label cannot be fully read comprises determining that a computer readable code on the label is incomplete or damaged.

5. The method of claim 3 wherein the label has a delivery point indicated thereon, and wherein determining the label cannot be fully read comprises determining that a delivery point cannot be interpreted by the scanner.

6. The method of claim 1, wherein redirecting the item to a relabeling component comprises:
determining that the item was scanned for a first time; and
redirecting the item being scanned for the first time to a flatten and face area of the sorting system.

7. The method of claim 1, wherein associating the delivery information with the new label comprises:
capturing an image of the label on the item;
transmitting the image to an image processing system;
extracting the delivery information from the label on the item; and
associating the extracted delivery information with the new label.

8. The method of claim 7, wherein extracting item or delivery information from a previous label of the item comprises:
transmitting the image of the label on the item to an automatic processing component; and
automatically converting text from the previous label into a digital format.

9. The method of claim 7, wherein extracting item or delivery information from the label on the item comprises:
transmitting the image of the previous label to a manual processing unit; and
manually converting text from the previous label into a digital format.

10. The method of claim 1, further comprising capturing by a relabeling scanner, an image of the item, the image including both the label and the new label.

11. A system for sorting and relabeling items, the system comprising:
a sorting component comprising:
at least one conveyor lane configured to transport a plurality of items, each of the items having a label thereon;
a scanner configured to read the label on each of the plurality of items to identify any of the plurality of items having unreadable or unscannable labels thereon;
a sorter configured to redirect items traveling on the at least one conveyor lane having unreadable or unscannable labels thereon; and
a relabeling component configured to apply a new label to each of redirected items having unreadable or unscannable labels thereon.

12. The system of claim 11 further comprising one or more processors in communication with the sorting component, wherein the one or more processors are configured to:
receive delivery information for one the items having unreadable or unscannable labels thereon;
associate the received delivery information for the one item of the redirected items with the new label applied to the one item of the redirected items.

13. The system of claim 12, wherein the scanner is further configured to image the label on each of the plurality of items, and wherein the one or more processors are further configured to receive the image of the label on one of the plurality of items and automatically convert text from the image into a digital format to generate the delivery information.

14. The system of claim 12, wherein the one or more processors are further configured to receive the delivery information from a manual processing component configured to receive an image of a label on an item and manually convert text from the image into a digital format.

15. The system of claim 11 wherein the relabeling component comprises:
a flatten and face area configured to flatten any bags and singulate any non singulated items; and
an item relabeling area configured to apply a new label to any items with an unreadable or unscannable label.

16. The system of claim 11, wherein the scanner is further configured to:
determine that one or more items of the plurality of items were scanned for a first time; and
redirect the item being scanned for the first time to a flatten and face area of the sorting system.

17. A method for relabeling items, the method comprising:
applying a new label to an item;
capturing an image of the previous label applied to the item;
transmitting the image to an image processing system;
extracting item or delivery information from the previous label of the item;
associating the item or delivery information with the new label; and
uploading the new label and item or delivery information to a database.

18. The method of claim 17, wherein applying a new label to an item comprises applying the new label to the item at a location proximate the previous label.

19. The method of claim 17, wherein extracting item or delivery information from a previous label of the item comprises:
transmitting the image to an automatic processing component;
automatically converting text from a previous label into a digital format;
determining the result of the automatic conversion;
transmitting the image to a manual processing unit if the result of the automatic conversion is unsuccessful; and
manually converting text from a previous label into a digital format if the result of the automatic conversion is unsuccessful.

20. The method of claim 17, further comprising sending the item or delivery information to a device that scans the new label.
